(19) United States
(12) Patent Application Publication
(10) Pub. No.: US 2017/0061311 A1
(43) Pub. Date: Mar. 2, 2017

(54) METHOD FOR PROVIDING DATA ANALYSIS SERVICE BY A SERVICE PROVIDER TO DATA OWNER AND RELATED DATA TRANSFORMATION METHOD FOR PRESERVING BUSINESS CONFIDENTIAL INFORMATION OF THE DATA OWNER

(71) Applicant: Li LIU, Woodland Hills, CA (US)

(72) Inventor: Li LIU, Woodland Hills, CA (US)

(21) Appl. No.: 14/837,828

(22) Filed: Aug. 27, 2015

(51) Int. Cl. G06N 7/00; H04L 29/08; G06N 99/00

(52) U.S. Cl. CPC G06N 7/005; G06N 99/005; H04L 67/1002

(57) ABSTRACT

Methods for providing data analysis service by a service provider to a data owner are described. The data owner transmits training data to the data analysis service provider, and the latter computes a model from the training data. In one method, the service provider transmits the model back to the data owner, which uses the model to generate predictions from prediction input. In another method, the data owner further transmits prediction input to the service provider, and the latter uses the computed model and the prediction input to generate predictions and then transmits the predictions back to the data owner. Prior to transmitting the training data and the prediction input, the data owner performs variable name anonymization and a variable transformation on the training data and prediction data point to obscure the meaning of the variables in the data. This prevents possible misuse of the data owner's data by unauthorized parties.

### BACKGROUND OF THE INVENTION

Field of the Invention

This invention relates to a method of providing data analysis service by a service provider to a data owner, and in particular, it relates to a method of data processing used in such as service provision model that preserves the business confidential information of the data owner.

Description of Related Art

Many of today's enterprises generate large amounts of data that can be analyzed to gain information valuable to the enterprise or to third parties. Here, the term enterprise is used to broadly include any entities, such a companies, government entities, non-profit entities, etc. For example, an e-commerce enterprise typically generates a large amount of data regarding user behavior on its e-commerce website, such as product searches, clicks, purchases, response to price display (e.g. purchase or no purchase, put on wish list), etc., on a daily basis. The enterprise may also gathers other user data such as user demographic data, data obtained from user devices used to access the e-commerce service such as locations of users' mobile devices, users' social network behavior, other data about users obtained from third party sources, etc. As physical devices are increasingly being connected electronically (the “Internet of things”), the data they generate are increasingly being gathered. Such physical devices may include personal wearable devices, household appliances, identifying devices attached to physical objects, monitoring devices installed in public and private places, etc. All of such data can be analyzed to gain valuable information.

Much has been written about “big data.” One characteristic of “big data” is the complexity of the data analysis. One recent paper defines bit data as follows: “Big Data represents the Information assets characterized by such a High Volume, Velocity and Variety to require specific Technology and Analytical Methods for its transformation into Value.” See De Mauroet al., What is big data? A consensual definition and a review of key research topics, AIP Conference Proceedings 1644: 97-104 (2015), available on the Internet at http://scitation.alp.org/content/aip/proceeding/aipcp/10.1063/1.4907823.

### SUMMARY

Embodiments of the present invention provide a method by which a specialized data analysis service provider provides data analysis service to a data owner. An object of the present invention is to provide a method to facilitate the data communication between a data analysis service provider and a data owner in a manner that preserves the business confidential information of the data owner.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a first server operated by a data owner and a second server operated by a data analysis service provider, which includes: (a) the first server transmitting training data to the second server; (b) the second server analyzing the training data received from the first server using machine learning to develop a model; (c) the first server transmitting a prediction input to the second server; (d) the second server computing a prediction using the model developed in step (b) and the prediction input received from the first server; and (e) the second server transmitting the prediction to the first server.

The method may further include, before step (a): (f) the first server obtaining data to be analyzed, the data including a plurality of data points, each data point including a first plurality of variables each having a value; (g) the first server pre-processing the data, including performing a variable transformation on each data point, to generate pre-processed data in which each data point includes a second plurality of variables each having a value, wherein at least one variable Xⱼ among the first plurality of variables is not among the second plurality of variables, and a set of replacement variables Zₛ to Zₜ among the second plurality of variables are not among the first plurality of variables; wherein in step (a), the first server transmits the pre-processed data as the training data to the second server; and the method may further include, before step (c): (h) the first server pre-processing a prediction data point, the prediction data point including the first plurality of variables each having a value, the pre-processing including performing the variable transformation on the prediction data point to generate pre-processed prediction data point which includes the second plurality of variables each having a value; wherein in (c), the first server transmits the pre-processed prediction data point as the prediction input to the second server.

In another aspect, the present invention provides a method implemented in a first server operated by a data owner and a second server operated by a data analysis service provider, which includes: (a) the first server transmitting training data to the second server; (b) the second server analyzing the training data received from the first server using machine learning to develop a model; (c) the second server transmitting the model to the first server; and (d) the first server computing a prediction using the model received from the second server and a prediction input.

The method may further include, before step (a): (e) the first server obtaining data to be analyzed, the data including a plurality of data points, each data point including a first plurality of variables each having a value; (f) the first server pre-processing the data, including performing a variable transformation on each data point, to generate pre-processed data in which each data point includes a second plurality of variables each having a value, wherein at least one variable Xⱼ among the first plurality of variables is not among the second plurality of variables, and a set of replacement variables Zₛ to Zₜ among the second plurality of variables are not among the first plurality of variables; wherein in step (a), the first server transmits the pre-processed data as the training data to the second server; the method may further include, before step (d): (g) the first server pre-processing a prediction data point, the prediction data point including the first plurality of variables each having a value, the pre-processing including performing the variable transformation on the prediction data point to generate pre-processed prediction data point which includes the second plurality of variables each having a value; wherein in (d), the first server transmits the pre-processed prediction data point as the prediction input to the second server.

In yet another aspect, the present invention provides a method implemented in a first server operated by a data owner, the first server cooperating with a second server operated by a data analysis service provider, the method including: (a) obtaining data to be analyzed, the data including a plurality of data points, each data point including a first plurality of variables each having a value; (b) pre-processing the data, including performing a variable transformation on each data point, to generate pre-processed data in which each data point includes a second plurality of variables each having a value, wherein at least one variable Xⱼ among the first plurality of variables is not among the second plurality of variables, and a set of replacement variables Zₛ to Zₜ among the second plurality of variables are not among the first plurality of variables; (c) transmitting the training data to the second server; and (d) pre-processing a prediction data point, the prediction data point including the first plurality of variables each having a value, the pre-processing including performing the variable transformation on the prediction data point to generate pre-processed prediction data point which includes the second plurality of variables each having a value.

The method may further include: (e) transmitting the pre-processed prediction data point as prediction input to the second server; and (f) receiving a prediction from the second server which has been computed by the second server based on the training data and the prediction input.

Alternatively, the method may further include: (e) receiving a model from the second server which has been learned by the second server from the training data; and (f) computing a prediction using the model received from the second server and the pre-processed prediction data point as prediction input.

The variable transformation in the pre-processing steps mentioned above may include: for the first variable Xⱼ, defining the set of replacement variables Zₛ to Zₜ which satisfy the condition:

Xⱼ=λ₀+λₛZₛ+ . . . +λₜZₜ

wherein λ₀, λₛ, . . . , λₜ are a set of coefficients, and wherein values of the set of replacement variables are dependent on the value of the first variable and/or auxiliary information, the auxiliary information being known to the first server but unknown to the second server.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIGS. 1A and 1B schematically illustrate methods for providing data analysis service by a service provider to data owners according to embodiments of the present invention.

FIG. 2 schematically illustrates a data pre-processing method that can be used in the embodiments of FIGS. 1A and 1B to anonymize and transform data to protect business confidential information of the data owner.

FIGS. 3A-3C schematically illustrates a mathematical explanation of the variable transformation according to embodiments of the present invention.

### DETAILED DESCRIPTION OF PREFERRED EMBODIMENTS

Given the complexity of data analysis, there is a need for specialized data analysis service providers that can provided data analysis service to data owners, in particular, to small and midsized enterprises. For example, even a small or midsized e-commerce company can benefit from analysis of data generated from its e-commerce website, for example, to predict individual customer behavior, to detect and predict trends related to its products and services, etc. This can improve decision making and increase operation efficiency of the enterprise. Specialized data analysis service providers can satisfy the data analysis needs of enterprises, in particular small and midsized enterprises which may not have in-house capabilities for complex data analysis. Accordingly, embodiments of the present invention provide methods for providing complex data analysis service by service providers to data owners.

Machine learning techniques, which can be used to analyze complex data to learn from and make predictions on the data, include two types of algorithms: supervised learning and unsupervised learning. In supervised learning, training data, which include independent variables and output variables, are used to develop a model. In unsupervised learning, the training data includes only input and no output, and the learning algorithm discovers structure in the input data. Data analysis employed in embodiments of the present invention can involve both supervised learning and unsupervised leaning, although the specific description below uses supervised learning as an example.

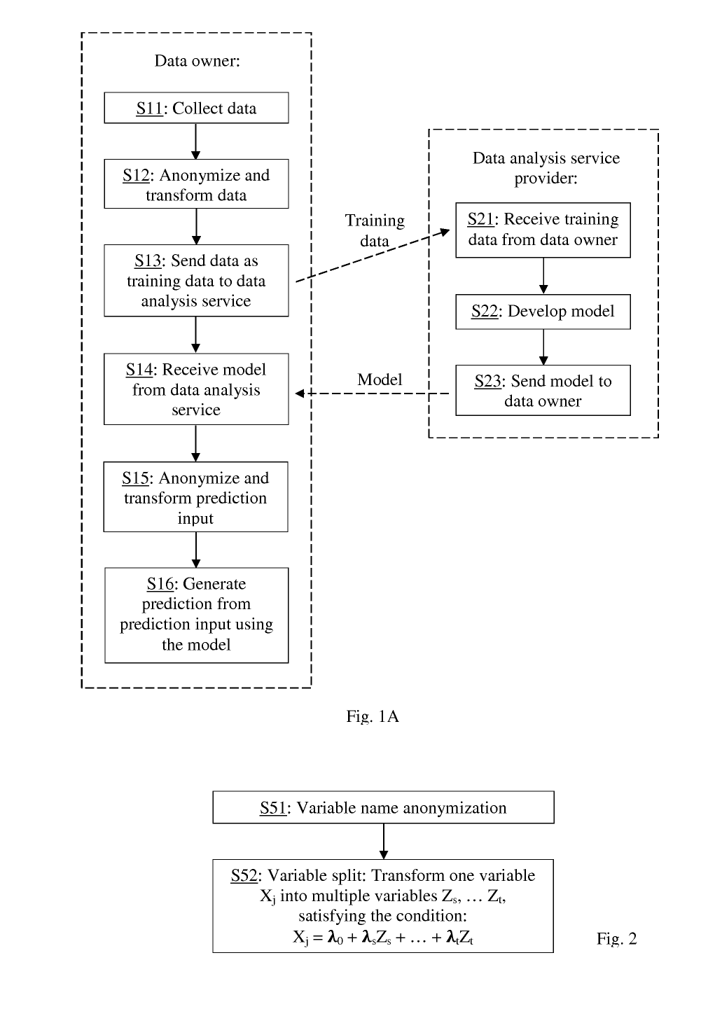

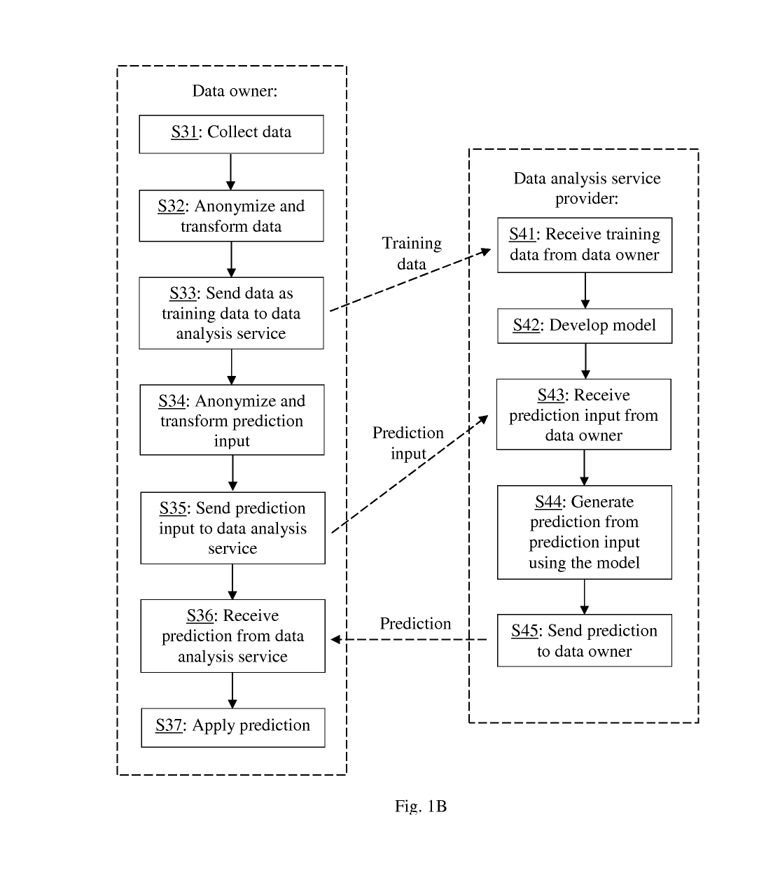

In a service provision method according to an embodiment of the present invention, as schematically illustrated in FIG. 1A, the enterprise (data owner) collects data (step S11) and transmits the data as training data to the data analysis service provider (steps S13, S21). The service provider analyzes the data, for example, using machine learning, to generate a model (step S22), and sends the model back to the data owner (steps S23, S14). The data owner applies the model, for example, using it to generate predictions from prediction input (step S16).

In one specific example, the data owner is an e-commerce enterprise which operates an e-commerce website. It collects user behavior data from its e-commerce website, and sends the collected data to the data analysis service provider at the end of each day. The data analysis service provider generates or updates the model from the training data, and sends the model back to the data owner. The data owner can then apply the model in its business, for example, changing displayed information on the e-commerce website, dynamically calculating predictions from prediction inputs using the model, etc.

In another service model, as schematically illustrated in FIG. 1B, after the data analysis service provider generates the model (step S42), the data owner sends the prediction input to the data analysis service provider (steps S35, S43), and the latter generates predictions using the model and the prediction input (step S44). The data analysis service provider sends the predictions back to the data owner (steps S45, S36), and the data owner can apply the prediction in suitable manners (step S37). The model does not need to be transmitted from the data analysis service provider to the data owner. In this method, steps S31, S33, S41 and S42 are similar to steps S11, S13, S21 and S22 in FIG. 1A.

One concern in these methods for providing data analysis service (both FIG. 1A and FIG. 1B) is the security of business confidential information of the data owner. This refers not only to the protection of privacy of the end customers of the enterprise, but also to the protection of sensitive business information that is valuable to the enterprise. In this regard, the model that can be learned from the training data, including what variables are used to learn the model, is itself valuable and sensitive business information. To protect such business information from possible misuse by the data analysis service provider by or hostile entities that obtain the training data or the model through unlawful means, the raw data collected by the data owner need to be pre-processed to render it abstract and “meaningless.” This way, hostile entities will not be able to understand the meaning of the model or the training data. This step of pre-processing the collected raw data to obscure the meaning of the variables is represented as steps S12, S15, S32 and S34 in the processes shown in FIGS. 1A and 1B, and its detail will be explained below.

An exemplary mathematical representation of the problem described above is presented below. This example uses supervised leaning. First, the regression analysis used in the learning process is expressed as:

Let X₁ . . . Xₖ be the independent variables (also referred to as the input variables or the predictor variables), and Y be the dependent variable (also referred to as the output variable or the response variable). The training data consist of n data points (observations):

Y₍₁₎, X₁₍₁₎, . . . , Xₖ₍₁₎

. . .

Y₍ₙ₎, X₁₍ₙ₎ₖ, . . . , Xₖ₍ₙ₎

Define X [symbol] fsi₍ᵢ₎ as the input of the i^{th} data point

[symbol]

fsi₍ᵢ₎=(1, X₁₍ᵢ₎, . . . , Xₖ₍ᵢ₎

A prediction model is developed by estimating

β^{̂}=(β₀,β₁, . . . , βₖ)=argmin_{β} Σ_{i=1 . . . n}Loss(y₍ᵢ₎, [symbol] fsi₍ᵢ₎β^{T}) (Eq. 1)

where argmin_{β}F is the value of the parameter β that minimizes the function F, and Loss(y₍ᵢ₎, [symbol] fsi₍ᵢ β^{T}) is a loss function dependent on the regression analysis method, such as:

Loss(y₍ᵢ₎, [symbol] fsi₍ᵢ₎β^{T})=(y₍ᵢ₎− [symbol] fsi₍ᵢ₎β^{T})² for linear regression, (Eq. 2)

Loss(y₍ᵢ₎, [symbol] fsi₍ᵢ₎β^{T}=log(1+ [symbol] ) for logistic regression. (Eq. 3)

Having obtained β^{̂}, the prediction Y in a linear regression model, or P(Y| [symbol] fsi) in a logistic regression model (the probability of the output being Y being +1 for a given prediction input [symbol] fsi), is:

Y= [symbol] fsiβ^{̂T} for linear linear regression (Eq. 4)

P(Y=1| [symbol] fsi)=1/(1+ [symbol] ) for logistic regression (Eq. 5)

A specific example is shown below, using logistic regression:
Y—Whether user purchases a piece of merchandise (+1 for yes, −1 for no)
X₁—User is female (1 for yes, 0 for no)
X₂—User is male (1 for yes, 0 for no)
X₃—User is [18-24] years of age (1 for yes, 0 for no)
X₄—User is [25-34] years of age (1 for yes, 0 for no)
. . .

The training data is:

$$\begin{matrix}{Y}_{( i )} , & {X}_{1 ( i )} , & {X}_{2 ( i )} , & {X}_{3 ( i )} , & {X}_{4 ( i )} , & … & ( 1 <= i <= n ) \\ - 1 , & 1 , & 0 , & 0 , & 1 , & … & \\ + 1 , & 1 , & 0 , & 1 , & 0 , & … & \\ - 1 , & 0 , & 1 , & 0 , & 0 , & … & \end{matrix}$$

From the training data, solve the estimation equation Eq. (1) using the loss function for logistic regression (Eq. (3)), i.e.,

β^{̂}=argmin_{β}Σ_{i=1 . . . n}log(1+ [symbol] ),

the following solution is obtained:

β^{̂}=(0.5, 3, 1, 1.5, 5, . . . )

which represents the model learned form the training data. Then, given a new data point, for example, a user who is female and [18-24] year of age . . . ,

[symbol]

fsi=(1, X₁=1, X₂=0, X₃=1, X₄=0, . . . )

the prediction P(Y=+1| [symbol] fsi), i.e., the probability that the user purchases the merchandise, is:

P(Y=+1 [symbol] fsi)=1/(1+ [symbol] )=1/(1+e^{-(0.5+3+0+1.5+0+ . . . )})

The data security problem discussed above, i.e. that of the security of business confidential information of the data owner, can be expressed as the following constraints which should be satisfied by the training data as released to the data analysis service provider:

(1) The meaning of each variable (X₁, X₂, . . . ) is not revealed by the training data. For example, it should not be revealed that X₁ means “is female” or X₁₀ means “merchandise is women's shoes.”

(2) If each original data point [symbol] fsi (1, X₁₍ᵢ₎, . . . , Xₖ₍ᵢ₎) is transformed into a data point [symbol] fsi₍ᵢ₎(1, Z₁₍ᵢ₎, . . . , Z₁₍ᵢ₎) and the transformed data set [symbol] fsi₍ᵢ₎ is used as training data released to the data analysis service provider in order to obscure the meaning of Xⱼ, the transformation g(·) ( [symbol] fsi₍ᵢ₎=g( [symbol] fsi₍ᵢ₎)) guarantees that the parameter β̂ learned from training data [symbol] fsi₍ⱼ₎ provides approximately equal prediction compared to the parameter β′̂ learned from the training data [symbol] fsi₍ᵢ₎; in other words,

P(Y=+1| [symbol] fsi)=1/(1+e⁻ [symbol] ^{fsi β}^{^{̂T}})≅PI(Y=+1| [symbol] fsi)=1/(1+e⁻ [symbol] ^{fsi β′}^{^{̂T}}) (Eq. 6)

Note that the original data points [symbol] fsi ₍ᵢ₎ each has k input values and the transformed data points [symbol] fsi₍ᵢ₎ each has l input values, and k and l are not required to be the same; in other words, the number of parameter values in β̂ and β′̂ are not required to be the same.

It should also be pointed out here that the problem that the above constraints solve is not primarily the protection against theft of individual records or data points, but to protect against theft of the data owner's business model, such as what input variable are being used for making predictions and what the calculated prediction model is.

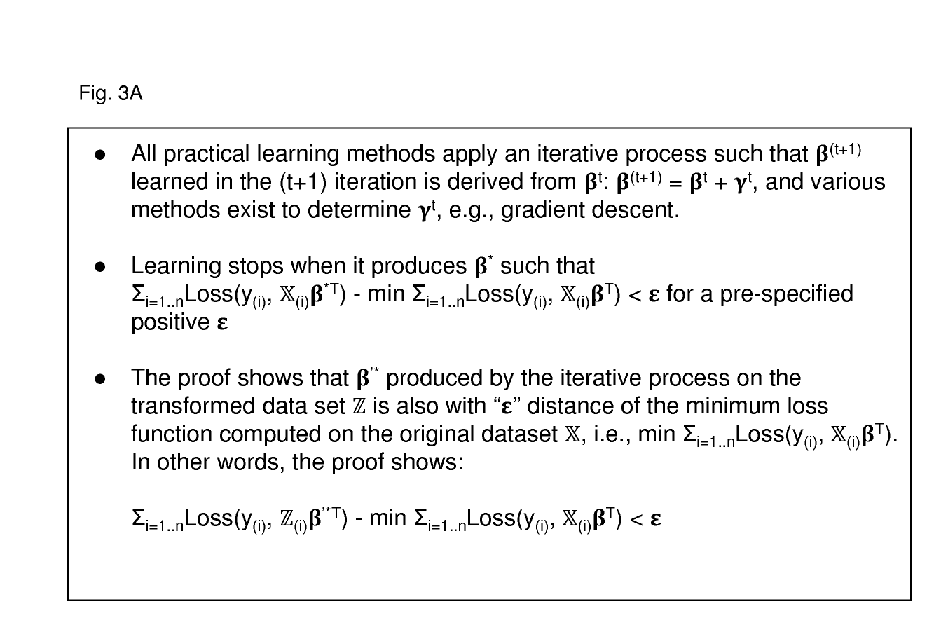

The second constraint above describes the requirement of the transformation g(·). An embodiment of the present invention provides a transformation that satisfies this constraint. A data pre-processing method according to this embodiment is described with reference to FIG. 2. First, the variable names in the collected data are anonymized so the variables are represented by abstract and meaningless names (step S51). For example, the variable “User is female” is anonymized to X₁, the variable “User is male” is anonymized to X₂, the variable “User is [18-24] years of age” is anonymized to X₃, etc.

It is evident that variable name anonymization does not impact learning and prediction results. However, while necessary, simply anonymizing variable name is insufficient because the characteristics of certain variables may still allow there meanings to be deduced from the data. For example, if the value of a variable equals 1 for approximately 50% of the training data, it can be deduced that this variable is likely a gender variable. If the value of another variable is 1 for approximately 13% of the training data, it can be deduced that this variable is likely the age bucket [18-24].

Therefore, a variable split is further performed (step S52). Specifically, for a variable with a generally publicly known distribution Xⱼ, such that the meaning of Xⱼ may be inferred by the data service provider from that distribution, Xⱼ is transformed into a set of other variables Zₛ . . . Zₜ which satisfy the condition

Xⱼ=λ₀+λₛZₛ+ . . . +λₜZₜ Eq. (7)

where λ₀, λₛ, . . . , λₜ are a set of coefficients. In the training data and the prediction input, the variable x, is not included, but the set of other variables Zₛ . . . Zₜ are included. Variable split increases the dimensionality of the data.

The variables Zₛ . . . Zₜ (referred to herein as the replacement variables) are defined by the data owner such that their values can be calculated from the value of the original variable being replaced (Xⱼ) along with certain auxiliary information known to the data owner; but both the auxiliary information and the relationship between the variables Zₛ . . . Zₜ and the original variable Xⱼ and the auxiliary information are unknown to the data analysis service provider (they are not disclosed as a part of the training data). The auxiliary information is not among the independent variables making up the data point; preferably, it should not even be related to or correlated with such independent variables. Further, the coefficients λ₀, λₛ, . . . , λₜ in Eq. (7) are defined by the data owner and unknown to the data service provider (they are not disclosed as a part of the training data).

The replacement variables Zₛ . . . Zₜ can be defined in any way, so long as the condition of Eq. (7) is satisfied. Preferably, they should be designed such that their distributions in the training data do not resemble the distribution of the original variable Xⱼ or have other characteristics that reveal their meanings or the meaning of the original variable. The coefficients λ₀, λₛ, . . . , λₜ provided in equation Eq. (7) increase the flexibility in designing the replacement variables. For example, using the coefficients, the distribution range of a replacement variable may be scaled or shifted up or down while still satisfy the condition of Eq. (7). The data owner has large freedom in designing the replacement variables for the purpose of obscuring the meaning of the training data. Two examples of the design of a set of replacement variables are given below.

In the first example, the original variable Xⱼ to be replaced is the user's gender, e.g., “Xⱼ=User is female.” This is a binary variable having a well-recognized distribution. The set of replacement variables with generally unknown distribution are defined based on the user's last name initial; for example, Z₁, Z₂ and Z₃ may be binary variables defined as:
Z₁=“User is female AND last name initial is in [A, M]”
Z₂=“User is female AND last name initial is in [N, S]”
Z₃=“User is female AND last name initial is in [T, Z]”
   Here, the user's last name initial is the auxiliary information known to the data owner and used to define the replacement parameters. The user's last name initial and the above alphabetical ranges in the definitions of Z₁, Z₂ and Z₃ are unknown to the data analysis service provider. Thus, the distributions of Z₁, Z₂ and Z₃ are unknown and unrecognizable, in particular because the three alphabetical ranges can be arbitrarily defined. In this example, the coefficients are λ₀=0 and λ₁=λ₂=λ₃=1. It can be seen that the condition of Eq. (7) is satisfied because the three alphabetical ranges are non-overlapping and collectively cover all possible last name initials. This way, the original binary variable Xⱼ is split into three replacement binary variables Z₁, Z₂ and Z₃, so that the original variable is not a part of the training data but the replacement variables are.

In a second example, the variable Xⱼ to be replaced is the height of a person (in meters), which is a continuous or multi-values discrete variable. The replacement variables are Z₁ and Z₂, which are defined as follows, again using the person's last name initial as the auxiliary information:

$${Z}_{1} = \{ \begin{matrix}- 13 , \\ - 12 , \\ … \\ 12 ,\end{matrix} \begin{matrix}if last name intitial is A \\ if last name initial is B \\ … \\ if last name initial is Z\end{matrix} \\ and \\ {Z}_{2} = ( {X}_{j} - 1.75 ) * 10 - {Z}_{1}$$

In this case, λ₀=1.75, and λ₁=λ₂=0.1. It can be easily seen that

Xⱼ=1.75+0.1*Z₁+0.1*Z₂

i.e. the condition of Eq. (7) is satisfied. It can be seen that the distribution of Z₁ is generally unknown and unrecognizable; the distribution of Z₂ is also generally unknown and unrecognizable because it is dependent on the distribution of Z₁.

In this example, the variable Z₁ has 26 discrete values; in alternative examples, the definition of Z₁ may be modified by combining some last name initials into ranges so that Z₁ has fewer possible values. Further, if it is desired to make the distribution of Z₁ fall in a particular numerical range, such as [0, 1], and/or to change the distribution range of Z₂, the values of λ₀, λ₁ and λ₂ may be changed.

From the above it can be seen that the design of the replacement variables can be very flexible to allow the data owner to obscure the meaning of his data.

In more general terms, the variable split is a transformation that transforms one variable Xᵢ into multiple replacement variables Zₛ, . . . Zₜ that satisfy the condition of Eq. (7).

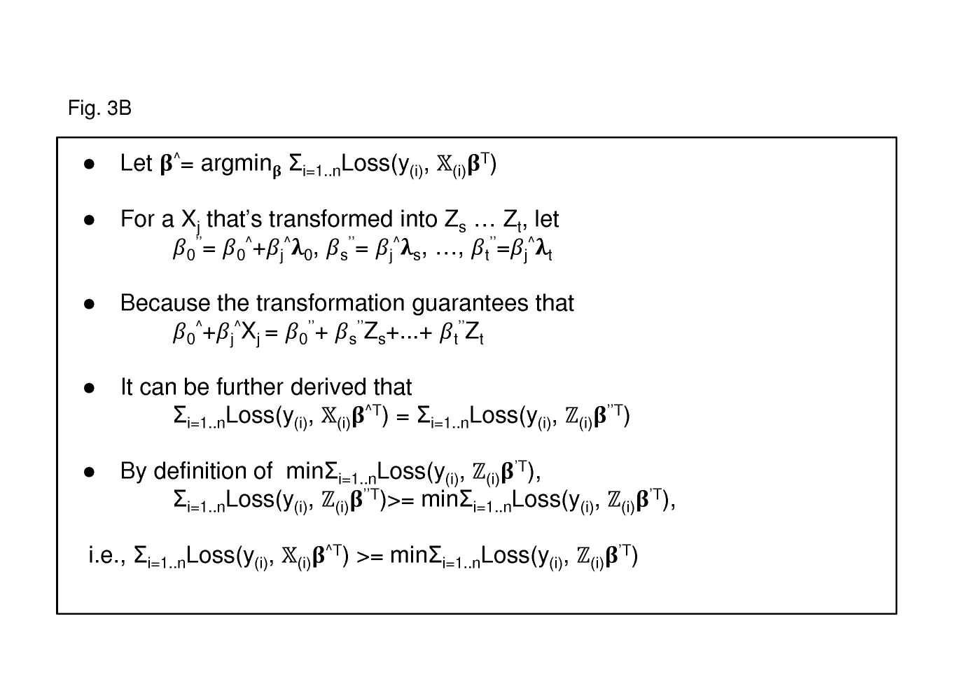

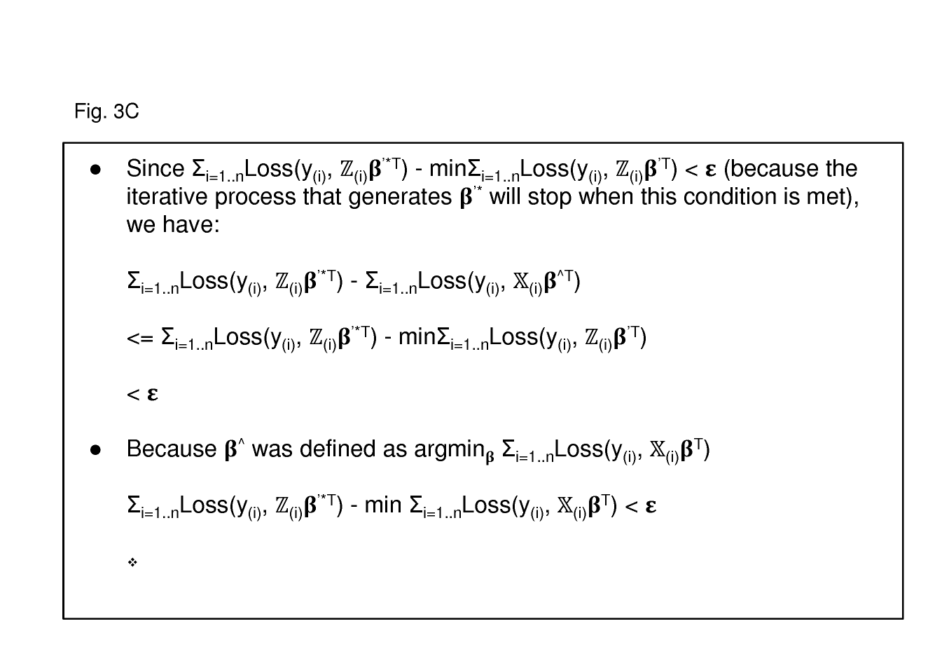

It can be shown that the variable split is a transformation that satisfies the second constraint set forth above, i.e., the model learned from the transformed data as training data provides approximately equal prediction compared to the model learned from the original data as training data. The proof is presented in FIGS. 3A-3C.

The variable anonymization and variable split shown in FIG. 2 is performed by the data owner both on the raw training data [symbol] ₍ᵢ₎ (1<=i<=n) before sending it to the data analysis service provider (step S12 in FIG. 1A and step S32 in FIG. 1B), and on the prediction input X that is used to compute the predictions of the model (step S15 in FIG. 1A and step S34 in FIG. 1B). This way, the predictions computed in step S16 in FIG. 1A and step S44 in FIG. 1B will be approximately the same as that which would have been computed had variable transformation not been applied to either the training data or the prediction input.

The methods and algorithms described above can be implemented in servers which includes processors and computer-usable non-transitory media (e.g. memory or storage device) having computer readable program code embedded therein for controlling the servers. For example, the method schematically shown in FIGS. 1A and 1B can be implemented by a server operated by the data owner and a server operated by the data analysis service provider.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method implemented in a first server operated by a data owner and a second server operated by a data analysis service provider, comprising:
(a) the first server transmitting training data to the second server;
(b) the second server analyzing the training data received from the first server using machine learning to develop a model;
(c) the first server transmitting a prediction input to the second server;
(d) the second server computing a prediction using the model developed in step (b) and the prediction input received from the first server; and
(e) the second server transmitting the prediction to the first server.

2. The method of claim 1, further comprising, before step (a):
(f) the first server obtaining data to be analyzed, the data including a plurality of data points, each data point including a plurality of variables each having a value; and
(g) the first server pre-processing the data, including performing a variable transformation on each data point, to generate pre-processed data, wherein the pre-processed data and the data to be analyzed have different variable value distributions;
wherein in step (a), the first server transmits the pre-processed data as the training data to the second server;
the method further comprising, before step (c):
(h) the first server pre-processing a prediction data point, the prediction data point including the plurality of variables each having a value, the pre-processing including performing the variable transformation on the prediction data point to generate pre-processed prediction data point;
wherein in (c), the first server transmits the pre-processed prediction data point as the prediction input to the second server.

3. The method of claim 1, further comprising, before step (a):
(f) the first server obtaining data to be analyzed, the data including a plurality of data points, each data point including a first plurality of variables each having a value;
(g) the first server pre-processing the data, including performing a variable transformation on each data point, to generate pre-processed data in which each data point includes a second plurality of variables each having a value, wherein at least one variable x, among the first plurality of variables is not among the second plurality of variables, and a set of replacement variables Zₛ to Zₜ among the second plurality of variables are not among the first plurality of variables;
wherein in step (a), the first server transmits the pre-processed data as the training data to the second server;
the method further comprising, before step (c):
(h) the first server pre-processing a prediction data point, the prediction data point including the first plurality of variables each having a value, the pre-processing including performing the variable transformation on the prediction data point to generate pre-processed prediction data point which includes the second plurality of variables each having a value;
wherein in (c), the first server transmits the pre-processed prediction data point as the prediction input to the second server.

4. The method of claim 3, wherein the variable transformation in the pre-processing steps (g) and (h) includes: for the first variable Xⱼ, defining the set of replacement variables Zₛ to Zₜ which satisfy the condition:
Xⱼ=λ₀+λₛZₛ+ . . . +λₜZₜ
wherein λ₀, λₛ, . . . , λₜ are a set of coefficients, and wherein values of the set of replacement variables are dependent on the value of the first variable and/or auxiliary information, the auxiliary information being known to the first server but unknown to the second server.

5. A method implemented in a first server operated by a data owner and a second server operated by a data analysis service provider, comprising:
(a) the first server transmitting training data to the second server;
(b) the second server analyzing the training data received from the first server using machine learning to develop a model;
(c) the second server transmitting the model to the first server; and
(d) the first server computing a prediction using the model received from the second server and a prediction input.

6. The method of claim 5, further comprising, before step (a):
(e) the first server obtaining data to be analyzed, the data including a plurality of data points, each data point including a plurality of variables each having a value; and
(f) the first server pre-processing the data, including performing a variable transformation on each data point, to generate pre-processed data, wherein the pre-processed data and the data to be analyzed have different variable value distributions;
wherein in step (a), the first server transmits the pre-processed data as the training data to the second server;
the method further comprising, before step (d):
(g) the first server pre-processing a prediction data point, the prediction data point including the plurality of variables each having a value, the pre-processing including performing the variable transformation on the prediction data point to generate pre-processed prediction data point;
wherein in (d), the first server uses the pre-processed prediction data point as the prediction input.

7. The method of claim 5, further comprising, before step (a):
(e) the first server obtaining data to be analyzed, the data including a plurality of data points, each data point including a first plurality of variables each having a value;
(f) the first server pre-processing the data, including performing a variable transformation on each data point, to generate pre-processed data in which each data point includes a second plurality of variables each having a value, wherein at least one variable Xⱼ among the first plurality of variables is not among the second plurality of variables, and a set of replacement variables Zₛ to Zₜ among the second plurality of variables are not among the first plurality of variables;
wherein in step (a), the first server transmits the pre-processed data as the training data to the second server;
the method further comprising, before step (d):
(g) the first server pre-processing a prediction data point, the prediction data point including the first plurality of variables each having a value, the pre-processing including performing the variable transformation on the prediction data point to generate pre-processed prediction data point which includes the second plurality of variables each having a value;
wherein in (d), the first server transmits the pre-processed prediction data point as the prediction input to the second server.

8. The method of claim 7, wherein the variable transformation in the pre-processing steps (f) and (g) includes: for the first variable Xⱼ, defining the set of replacement variables Zₛ to Zₜ which satisfy the condition:
Xⱼ=λ₀+λₛZₛ+ . . . λₜZₜ
wherein λ₀, λₛ, . . . , λₜ are a set of coefficients, and wherein values of the set of replacement variables are dependent on the value of the first variable and/or auxiliary information, the auxiliary information being known to the first server but unknown to the second server.

9. A method implemented in a first server operated by a data owner, the first server cooperating with a second server operated by a data analysis service provider, the method comprising:
(a) obtaining data to be analyzed, the data including a plurality of data points, each data point including a first plurality of variables each having a value;
(b) pre-processing the data, including performing a variable transformation on each data point, to generate pre-processed data in which each data point includes a second plurality of variables each having a value, wherein at least one variable Xⱼ among the first plurality of variables is not among the second plurality of variables, and a set of replacement variables Zₛ to Zₜ among the second plurality of variables are not among the first plurality of variables;
(c) transmitting the training data to the second server; and
(d) pre-processing a prediction data point, the prediction data point including the first plurality of variables each having a value, the pre-processing including performing the variable transformation on the prediction data point to generate pre-processed prediction data point which includes the second plurality of variables each having a value.

10. The method of claim 9, further comprising:
(e) transmitting the pre-processed prediction data point as prediction input to the second server; and
(f) receiving a prediction from the second server which has been computed by the second server based on the training data and the prediction input.

11. The method of claim 9, further comprising:
(e) receiving a model from the second server which has been learned by the second server from the training data; and
(f) computing a prediction using the model received from the second server and the pre-processed prediction data point as prediction input.

12. The method of claim 9, wherein the variable transformation in the pre-processing steps (b) and (d) includes: for the first variable Xⱼ, defining the set of replacement variables Zₛ to Zₜ which satisfy the condition:
Xⱼ=λ₀+λₛZₛ+ . . . λₜZₜ
wherein λ₀, λₛ, . . . λₜ are a set of coefficients, and wherein values of the set of replacement variables are dependent on the value of the first variable and/or auxiliary information, the auxiliary information being known to the first server but unknown to the second server.
